(19) United States
(12) Patent Application Publication
(10) Pub. No.: US 2010/0198406 A1
(43) Pub. Date: Aug. 5, 2010

(54) ELECTRONIC PET SYSTEM AND CONTROL METHOD OF AN ELECTRONIC PET

(76) Inventor: Ming-Shu Lin, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/699,860

(22) Filed: Feb. 3, 2010

(30) Foreign Application Priority Data
Feb. 4, 2009 (TW) 098103450

(51) Int. Cl. G06F 19/00; G05B 15/00

(52) U.S. Cl. 700/258; 901/1

(57) ABSTRACT

An electronic pet system includes an electronic pet and a glove. The electronic pet includes a first central processing unit (CPU) and a wireless receiver. The glove includes a plurality of accelerometers, a wireless transmitter, and a second CPU. When the glove is moved, acceleration of the accelerometers will be measured. If the measurements of acceleration match a predetermined instruction, the electronic pet will be directed to make a move according to the predetermined instruction.

### BACKGROUND OF THE INVENTION

1. Field of the Invention

The present invention relates to an electronic pet system and a control method of an electronic pet, and more particularly, to an electronic pet system and a control method of an electronic pet utilizing accelerometers.

2. Description of the Prior Art

A conventional electronic pet is equipped with many sensors to sense direct contacts. That is, the response of the electronic pet is triggered by petting the electronic pet. However, a genuine pet does not need physical contact to generate a response. Thus the prior art is unable to realistically imitate the interaction between a human being and a pet, reducing the joy of playing with the electronic pet.

Another convention electronic pet does not need to be triggered by direct contact. The electronic pet is able to recognize certain sign patterns. First, sign patterns are recorded by an image sensor. Then the sign patterns are interpreted by performing software image operations to generate their meanings. Due to hardware and software cost, products able to recognize sign patterns are usually high level products or are made for academic purposes. Commercial electronic products rarely have this function. In other words, an electronic pet has to be equipped with a visual lens, and provided with complicate image process means to possess this function. This will require the CPU to perform powerful and complicate operations, thus consuming a lot of power. Another electronic pet uses acoustically conveyed sound patterns to recognize instructions. However, both sign pattern and sound pattern recognition systems are very costly, making them unaffordable to the general public.

### SUMMARY OF THE INVENTION

According to an embodiment of the present invention, an electronic pet system comprises an electronic pet and a control object. The electronic pet comprises a first central processing unit (CPU) and a wireless receiver electrically connected to the first CPU. The control object comprises a plurality of accelerometers, a wireless transmitter for wireless communication with the wireless receiver, and a second CPU electrically connected to the accelerometers and the wireless transmitter. When the control object is moved, the accelerometers are used for measuring acceleration of the control object. The second CPU is used for determining whether measurements of acceleration obtained by the accelerometers match a predetermined instruction. If the measurements match the predetermined instruction, the first CPU is used for directing the electronic pet to make a move according to the predetermined instruction.

According to another embodiment of the present invention, a control method of an electronic pet comprises providing an electronic pet comprising a first CPU and a wireless receiver, providing a control object comprising a plurality of accelerometers, a second CPU and a wireless transmitter, and measuring acceleration of the control object by using the accelerometers. If the measurements of acceleration match a predetermined instruction, direct the electronic pet to make a move according to the predetermined instruction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an electronic pet system according to an embodiment of the present invention.

FIG. 2 is a circuit diagram of the electronic pet system in FIG. 1.

FIG. 3 is a flowchart of a control method for controlling the electronic pet in FIG. 1.

FIG. 4 shows instructions, and signs, movements and acceleration corresponding to the instructions according to an embodiment of the present invention.

### DETAILED DESCRIPTION

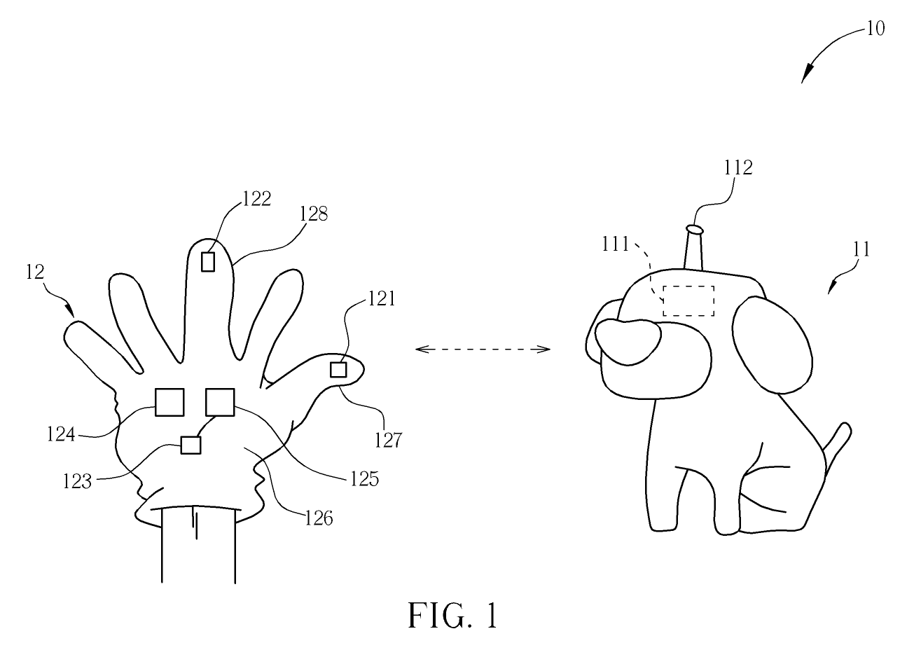

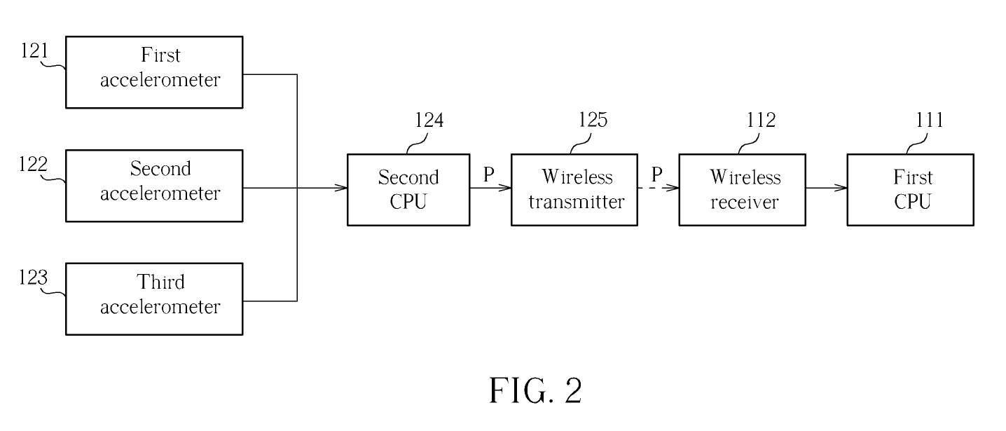

Please refer to FIGS. 1 and 2. FIG. 1 shows an electronic pet system 10 according to an embodiment of the present invention. FIG. 2 is a circuit diagram of the electronic pet system 10. The electronic pet system 10 comprises an electronic pet 11 and a control object 12. The electronic pet 11 comprises a first central processing unit (CPU) 111 and a wireless receiver 112 electrically connected to the first CPU 111. The control object 12 comprises a first accelerometer 121, a second accelerometer 122, a third accelerometer 123, a second CPU 124 and a wireless transmitter 125. The first accelerometer 121, second accelerometer 122, and third accelerometer 123 are electrically connected to the second CPU 124. The second CPU 124 is electrically connected to the wireless transmitter 125.

When the control object 12 is moved, acceleration of the first accelerometer 121, second accelerometer 122, and third accelerometer 123 will be measured. If the measurements of acceleration match a predetermined instruction, the electronic pet 11 will be directed to make a move according to a control signal generated according to the predetermined instruction.

In this embodiment, the control object 12 is a glove for an operator to wear. The glove includes a palm portion 126, a thumb portion 127 and a finger portion 128. The first accelerometer 121 is disposed on the thumb portion 127. The second accelerometer 122 is disposed on the finger portion 128. The third accelerometer 123 is disposed on the palm portion 126. The finger portion 128 includes sheaths for accommodating all four fingers. The second accelerometer 122 is disposed on the sheath for accommodating a middle finger, or any of the remaining three fingers. Further, the wireless receiver 112 and the wireless transmitter 125 in this embodiment can be a Bluetooth receiver and a Bluetooth transmitter respectively.

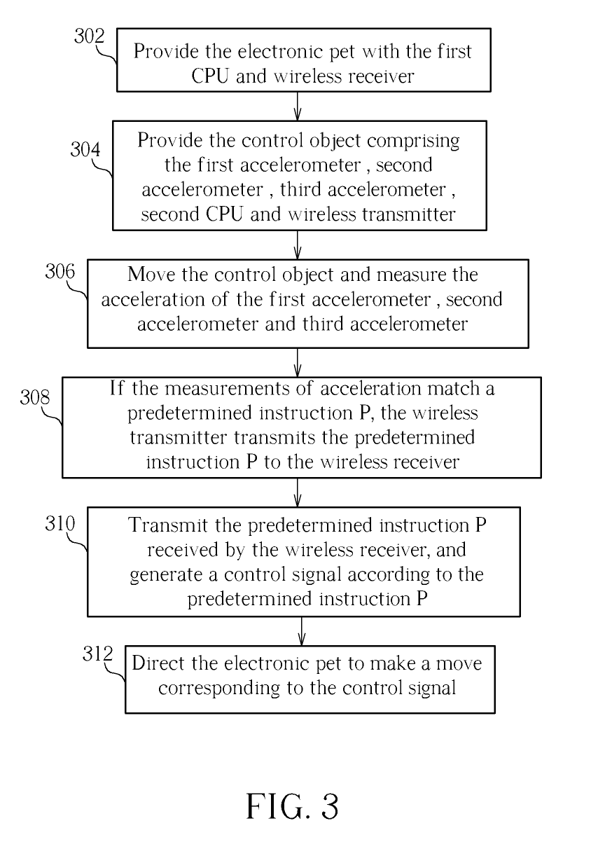

FIG. 3 is a flowchart of a control method for controlling the electronic pet 11. The control method comprises the following steps:

Step 302: Provide the electronic pet 11 with the first CPU and wireless receiver 112;

Step 304: Provide the control object 12 comprising the first accelerometer 121, second accelerometer 122, third accelerometer 123, second CPU 124 and wireless transmitter 125;

Step 306: Move the control object 12 and measure the acceleration of the first accelerometer 121, second accelerometer 122 and third accelerometer 123;

Step 308: If the measurements of acceleration match a predetermined instruction P, the wireless transmitter 125 transmits the predetermined instruction P to the wireless receiver 112;

Step 310: Transmit the predetermined instruction P received by the wireless receiver 112, and generate a control signal according to the predetermined instruction P;

Step 312: Direct the electronic pet 11 to make a move corresponding to the control signal.

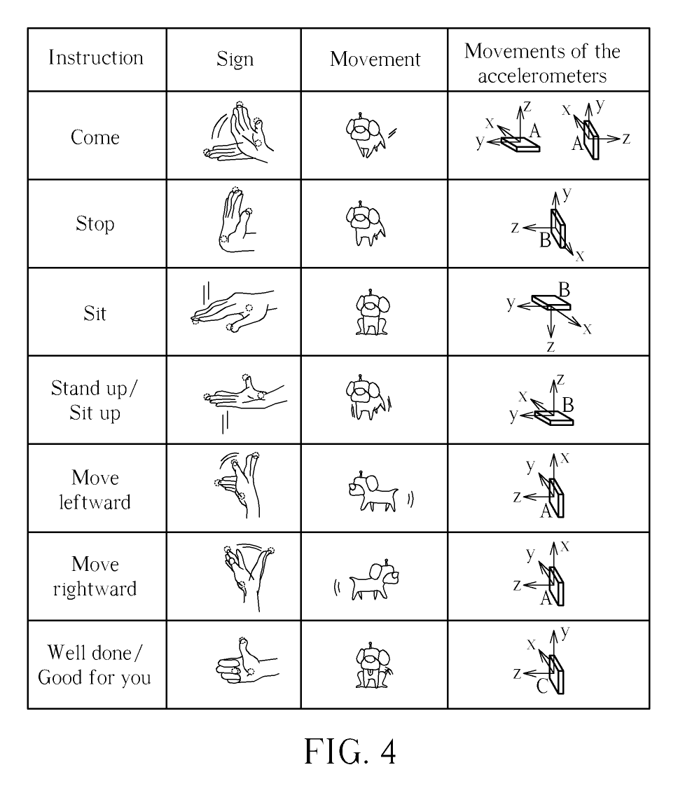

Please refer to FIG. 4. FIG. 4 shows instructions, and signs, movements and movements of the accelerometers 121, 122, 123 corresponding to the instructions. In FIG. 4, A refers to the second accelerometer 122. B refers to the third accelerometer 123. C refers to the first accelerometer 121. Referring to FIG. 1 as well, if the operator wants to issue the instruction to come, the operator gestures the sign to come. This gesture would cause the measurements of acceleration of both y and z axes of the second accelerometer 122 to be greater than the first and third accelerometers 121, 123. A minor acceleration of x axis of the second accelerometer 122 would also be measured. By using software means, the minor acceleration of x axis of the second accelerometer 122 can be ignored. And the substantial 90-degree phase changes of both y and z axes of the second accelerometer would cause the second CPU 124 to transmit the instruction to come to the wireless transmitter 125. Then the instruction to come would be transferred to the first CPU 111 through the wireless receiver 112. Lastly, the first CPU 111 would issue a control signal to direct the electronic pet 11 to make a move corresponding to the instruction to come.

If the operator wants to issue the instruction to stop, the operator gestures the sign to stop. The sign to stop corresponds to a flat vertically positioned palm. Without considering the errors of the first and second accelerometers 121, 122, the third accelerometer 123 still remains in the position shown in FIG. 4 for a predetermined period of time. That is, the measurement of acceleration along a y axis of the third accelerometer 123, obtained by the third accelerometer in a predetermined period, is substantially equal to a predetermined acceleration. In this embodiment, the predetermined acceleration is substantially equal to 9.8 m/s². And the measurements of acceleration along x and z axes of the third accelerometer 123 in the predetermined period are both substantially 0 m/s². In this case, the second CPU 124 will determine that the instruction refers to the instruction to stop. And the instruction to stop would be transferred to the wireless transmitter 125, then to the first CPU 111 through the wireless receiver 112. Lastly, the first CPU 111 would issue a control signal to direct the electronic pet 11 to make a move corresponding to the instruction to stop.

If the operator wants to issue the instruction to sit, the operator gestures the sign to sit. The sign to sit corresponds to a downward facing flat palm pushing downward. Thus when the second CPU determines that downward acceleration along the z axis of the third accelerometer, measured by the third accelerometer 123 in a predetermined period, has increased by over a certain amount, the instruction to sit is recognized. When the instruction to sit is recognized, the second CPU 124 would transfer the instruction to sit to the wireless transmitter 125, then to the first CPU 111 through the wireless receiver 112. Lastly, the first CPU 111 would issue a control signal to direct the electronic pet 11 to make a move corresponding to the instruction to sit.

If the operator wants to issue the instruction to stand up or sit up, the operator gestures the sign to stand up or sit up. The sign to stand up or sit up corresponds to an upward facing flat palm moving upward. Thus when the second CPU determines that upward acceleration along a z axis of the third accelerometer, measured by the third accelerometer in a predetermined period, has increased by over a certain amount, the instruction to stand up or sit up is recognized. But the acceleration is a sudden decrease instead of a sudden increase because the palm is moving upward instead of downward. When the instruction to stand up or sit up is recognized, the second CPU 124 would transfer the instruction to stand up or sit up to the wireless transmitter 125, then to the first CPU 111 through the wireless receiver 112. Lastly, the first CPU 111 would issue a control signal to direct the electronic pet 11 to make a move corresponding to the instruction to stand up or sit up.

If the operator wants to issue the instruction to move rightward or move leftward, the operator gestures the sign to move rightward or move leftward. The sign to move rightward or move leftward corresponds to the swing of four fingers. Thus when the second CPU determines that rightward or leftward acceleration along a z axis of the second accelerometer, measured by the second accelerometer in a predetermined period, has increased by over a certain amount, the instruction to move rightward or move leftward is recognized. If the change of acceleration along the z axis of the second accelerometer 122 is positive, then the instruction to move rightward is recognized. If the change of acceleration along the z axis of the second accelerometer 122 is negative, then the instruction to move leftward is recognized. When the instruction to move rightward or move leftward is recognized, the second CPU 124 would transfer the instruction to move rightward or move leftward to the wireless transmitter 125, then to the first CPU 111 through the wireless receiver 112. Lastly, the first CPU 111 would issue a control signal to direct the electronic pet 11 to make a move corresponding to the instruction to move rightward or move leftward.

Last, if the operator wants to issue the expression of approval meaning the electronic pet has done well, the operator gestures the sign meaning well done or good for you. The sign meaning well done or good for you corresponds to a thumbs up gesture. Thus when the second CPU determines that a measurement of acceleration along a y axis of the first accelerometer, obtained by the first accelerometer in a predetermined period, is substantially equal to a predetermined acceleration, the expression of approval meaning the electronic pet has done well is recognized. In this embodiment, the predetermined acceleration is substantially equal to 9.8 m/s². When the expression of approval meaning the electronic pet has done well is recognized, the second CPU 124 would transfer the expression of approval meaning the electronic pet has done well to the wireless transmitter 125, then to the first CPU 111 through the wireless receiver 112. Lastly, the first CPU 111 would issue a control signal to direct the electronic pet 11 to make a move corresponding to the expression of approval meaning the electronic pet has done well.

Thus the electronic pet system 10 and the method to control the electronic pet 11 use low cost accelerometers to control the electronic pet 11. It does not require direct petting of the electronic pet 11 to trigger its response. Thus it can better imitate the interaction between a genuine pet and a human being, enhancing the fun to entertain the electronic pet 11.

Those skilled in the art will readily observe that numerous modifications and alterations of the device and method may be made while retaining the teachings of the invention.

What is claimed is:

1. An electronic pet system comprising:
an electronic pet comprising a first central processing unit (CPU) and a wireless receiver electrically connected to the first CPU; and
a control object comprising a plurality of accelerometers, a wireless transmitter for wireless communication with the wireless receiver, and a second CPU electrically connected to the accelerometers and the wireless transmitter;
wherein when the control object is moved, the accelerometers are used for measuring acceleration of the control object, the second CPU is used for determining whether measurements of acceleration obtained by the accelerometers match a predetermined instruction; and if the measurements match the predetermined instruction, the first CPU is used for directing the electronic pet to make a move according to the predetermined instruction.

2. The electronic pet system of claim 1, wherein the control object is a glove for an operator to wear.

3. The electronic pet system of claim 2, wherein the plurality of accelerometers comprise a first accelerometer, a second accelerometer and a third accelerometer.

4. The electronic pet system of claim 3, wherein the glove comprises a palm portion, a thumb portion, and a finger portion, and the first accelerometer is disposed on the thumb portion, the second accelerometer is disposed on the finger portion, and the third accelerometer is disposed on the palm portion.

5. The electronic pet system of claim 1, wherein the wireless receiver and the wireless transmitter are a Bluetooth receiver and a Bluetooth transmitter respectively.

6. A control method of an electronic pet comprising:
providing an electronic pet comprising a first CPU and a wireless receiver;
providing a control object comprising a first accelerometer, a second accelerometer, a third accelerometer, a second CPU, and a wireless transmitter;
measuring acceleration of the control object by using the first accelerometer, the second accelerometer, and the third accelerometer; and
if the measurements of acceleration match a predetermined instruction, directing the electronic pet to make a move according to the predetermined instruction.

7. The control method of claim 6, further comprising the wireless transmitter transmitting the predetermined instruction to the wireless receiver if the measurements match the predetermined instruction.

8. The control method of claim 7 further comprising transmitting the predetermined instruction received by the wireless receiver, and generating a control signal according to the predetermined instruction so as to direct the electronic pet to make the move corresponding to the control signal.

9. The control method of claim 6, wherein the control object is a glove comprising a palm portion, a thumb portion, and a finger portion, and the first accelerometer is disposed on the thumb portion, the second accelerometer is disposed on the finger portion, and the third accelerometer is disposed on the palm portion.

10. The control method of claim 9, wherein when the second CPU determines that measurements obtained by the second accelerometer indicate substantial 90-degree phase changes of both y and z axes of the second accelerometer, the predetermined instruction is an instruction to come.

11. The control method of claim 9, wherein when the second CPU determines that a measurement of acceleration along a y axis of the third accelerometer, obtained by the third accelerometer in a predetermined period, is substantially equal to a predetermined acceleration, and that measurements along x and z axes of the third accelerometer in the predetermined period are both substantially 0 m/s², the predetermined instruction is an instruction to stop.

12. The control method of claim 11, wherein the predetermined acceleration is substantially equal to 9.8 m/s².

13. The control method of claim 9, wherein when the second CPU determines that downward acceleration along a z axis of the third accelerometer, measured by the third accelerometer in a predetermined period, has increased by over a certain amount, the predetermined instruction is an instruction to sit.

14. The control method of claim 9, wherein when the second CPU determines that upward acceleration along a z axis of the third accelerometer, measured by the third accelerometer in a predetermined period, has increased by over a certain amount, the predetermined instruction is an instruction to stand up or sit up.

15. The control method of claim 9, wherein when the second CPU determines that rightward acceleration along a z axis of the second accelerometer, measured by the second accelerometer in a predetermined period, has increased by over a certain amount, the predetermined instruction is an instruction to move rightward.

16. The control method of claim 9, wherein when the second CPU determines that leftward acceleration along a z axis of the second accelerometer, measured by the second accelerometer in a predetermined period, has increased by over a certain amount, the predetermined instruction is an instruction to move leftward.

17. The control method of claim 9, wherein when the second CPU determines that a measurement of acceleration along a y axis of the first accelerometer, obtained by the first accelerometer in a predetermined period, is substantially equal to a predetermined acceleration, the predetermined instruction is an expression of approval meaning the electronic pet has done well.

18. The control method of claim 17 wherein the predetermined acceleration is substantially equal to 9.8 m/s².
